(19) United States
(12) Patent Application Publication
(10) Pub. No.: US 2013/0333377 A1
(43) Pub. Date: Dec. 19, 2013

(54) ELECTROMECHANICAL BRAKE BOOSTER WITH ADJUSTABLE NON-LINEAR ASSISTANCE FORCE

(71) Applicants: Lin Feuerrohr, Rutesheim (DE); Jochen Moench, Sinzheim (DE); Christian Meyer, Karlsruhe-Wolfartsweier (DE); Hans-Peter Dommsch, Lichtenau (DE); Stefan Demont, Buehl (DE); Martin-Peter Bolz, Buehl (DE); Jean-Marc Ritt, Strasbourg (FR)

(72) Inventors: Lin Feuerrohr, Rutesheim (DE); Jochen Moench, Sinzheim (DE); Christian Meyer, Karlsruhe-Wolfartsweier (DE); Hans-Peter Dommsch, Lichtenau (DE); Stefan Demont, Buehl (DE); Martin-Peter Bolz, Buehl (DE); Jean-Marc Ritt, Strasbourg (FR)

(73) Assignee: ROBERT BOSCH GMBH, Stuttgart (DE)

(21) Appl. No.: 13/993,073

(22) PCT Filed: Nov. 16, 2011
(86) PCT No.: PCT/EP2011/070231

§ 371 Date: Aug. 26, 2013

(30) Foreign Application Priority Data
Dec. 10, 2010 (DE) 10 2010 062 785.2

(51) Int. Cl. F15B 15/00

(52) U.S. Cl. CPC F15B 15/00
USPC 60/545

(57) ABSTRACT

The present invention relates to an electromechanical brake booster with adjustable non-linear assistance force, comprising a brake booster piston (10), an adjustment means (50) which can be moved in a translatory fashion, and a non-linear coupling mechanism (40) for coupling the brake booster piston (10) to the adjustment means (50) in order to apply variable force to the brake booster piston (10).

### BACKGROUND OF THE INVENTION

The present invention relates to electromechanical brake boosters, in particular brake boosters with a non-linear assistance force that can be adjusted by electric motor.

A brake booster helps to relieve the driver when braking since the brake booster exerts an assistance force on the brake master cylinder when the brake pedal is actuated, and this force then acts on the cylinder in addition to the brake pedal force. The actuating force at the brake pedal of a vehicle which is required to achieve the desired braking effect is thus reduced. In the majority of vacuum brake boosters installed in cars and light commercial vehicles, the assistance force of the brake booster is produced by means of a pressure difference (atmospheric pressure to the vacuum at the engine).

However, there is virtually no pressure difference available for the operation of a vacuum brake booster at the engine any longer in the case of diesel engines and modern direct injection FSI engines. In the case of engines of this kind, therefore, additionally installed electric vacuum pumps or vacuum pumps driven by the internal combustion engine ensure the necessary vacuum to operate the brake booster. However, these are disadvantageous owing to the required tubing, the associated, relatively large installation space and an unwanted increase in the weight of the vehicle.

One alternative thereto are what are referred to as electromechanical brake boosters, where an electric motor produces a torque that is converted by means of a coupling device into the assistance force of the brake booster.

WO 2008/128811 A1 has disclosed an electromechanical brake booster in which an electric motor drives a mechanical mechanism with a variable transmission ratio which provides the assistance force for the brake master cylinder. The disadvantage here is that, in the case of the mechanical mechanism, at least one combination of a rack and a pinion is required for variable transmission of the assistance force for the brake master cylinder, but, due to the principle involved, this always has backlash in the system. Moreover, the mechanical mechanism requires a mounting arrangement with a correspondingly large installation space and involved assembly of precision-manufactured and therefore expensive components.

### SUMMARY OF THE INVENTION

It is therefore an object of the present invention to provide an electromechanical brake booster having a simplified mechanical mechanism, in which the assistance force for the brake cylinder can be adjusted in a variable manner in relation to the position of the brake pedal. Moreover, in the case of the electromechanical brake booster under consideration the backlash in the system is to be reduced and the required components for the brake booster are to be simplified in terms of manufacture and assembly.

According to the invention, this object is achieved by the electromechanical brake booster as described below.

According to a first aspect, an electromechanical brake booster with adjustable non-linear assistance force is provided, comprising:
a brake booster piston,
an adjustment means, which can be moved in a translatory fashion, and
a non-linear coupling mechanism for coupling the brake booster piston to the adjustment means in order to exert a variable force on the brake booster piston.

The brake booster can furthermore comprise:
a threaded spindle, and
an electric motor for driving the threaded spindle,

wherein the threaded spindle is coupled to the adjustment means in order to move the adjustment means along a longitudinal axis of the threaded spindle by driving the threaded spindle.

In particular, the coupling mechanism can have at least one first lever arm and at least one second lever arm.

In the electromechanical brake booster under consideration, the use of a mechanical mechanism having a combination of a rack and a pinion to achieve the variable transmission ratio can be eliminated since, in this case, a simple lever arm principle is employed. In the electromechanical brake booster under consideration, this also results in a reduction in the backlash in the system as compared with systems involving gearwheels, thereby increasing the accuracy of control and comfort for the driver.

In the electromechanical brake booster under consideration, the coupling mechanism transmits a non-linear assistance force to the brake booster piston during operation as a function of the position of the adjustment means on the threaded spindle, this force being intensified in proportion to the selected lengths of the lever arms of the coupling mechanism. In general terms, coupling mechanisms are mechanisms which convert a rotary motion into rectilinear or oscillating motion or vice versa, and these are furthermore mechanisms with nonuniform transmission ratios. Owing to the lever arm effect, the assistance force is non-linear in relation to the position of the adjustment means on the threaded spindle, and this is advantageous for the intensification of the braking force since this intensification is intended to increase in a non-linear fashion as the brake pedal is increasingly depressed.

Another advantage of the electromechanical brake booster under consideration consists in the small number and simple design of the parts required to achieve the variable transmission ratio by means of the coupling mechanism. Thus, the coupling mechanism under consideration, in its simplest form, requires just two lever arms of different lengths for this purpose, each coupled to one another in an articulated fashion and likewise coupled in an articulated fashion to the adjustment means and the brake booster piston, thereby considerably reducing the outlay on manufacture and assembly. In the case of the electromechanical brake booster under consideration, the installation of the expensive combination of a rack and pinion and the associated mounting arrangement is eliminated.

In the case of the electromechanical brake booster under consideration, the lever arms of the coupling mechanism can furthermore each be arranged symmetrically on opposite sides of the adjustment means and the brake booster piston. If the joints and levers of the coupling mechanism are duplicated, i.e. if they are arranged on each side of the adjustment means and of the brake booster piston, the forces on each side of the brake booster piston and of the adjustment means compensate each other, and therefore no moment is exerted on said components.

In addition, the first lever arm of the coupling mechanism can be coupled in an articulated fashion to the adjustment means. This articulated coupling preferably has just one degree of freedom, in particular a rotational degree of freedom. This attachment ensures simple, direct and strain-free coupling of the coupling mechanism to the adjustment means.

In the electromechanical brake booster under consideration, the adjustment means can be a one-piece component. Thus, the adjustment means in its simplest form can be designed in the manner of a screw nut or of a sleeve with an internal thread matching the thread of the threaded spindle, for example, and can have a means for articulated coupling to the first lever arm of the coupling mechanism. As an alternative, the adjustment means can also be an integral component.

In the electromechanical brake booster under consideration, it is furthermore possible for the threaded spindle to be arranged above the brake booster piston. In an equally ranked alternative of the electromechanical brake booster, the threaded spindle can be arranged below the brake booster piston. Here, the installation position of the threaded spindle and of the adjustment means relative to the brake booster piston can be selected according to the wishes of the vehicle manufacturer. Preferably, the axis of rotation of the threaded spindle and the axis of symmetry of the brake booster piston are situated in a common vertical plane.

Moreover, the adjustment means can move away from the brake booster piston during operation to provide an increasing assistance force on said piston. Here, the starting position when the brake pedal is not actuated is selected as a reference point for the position of the adjustment means, the adjustment means being situated closest to the electric motor in this starting position.

According to a preferred embodiment of the electromechanical brake booster, the coupling mechanism can have a third lever arm, and the second lever arm is coupled in an articulated fashion to a third lever arm, and the third lever arm is coupled in an articulated fashion to the vehicle. Thus, in particular, one longitudinal end of the second lever arm is coupled in an articulated fashion to the third lever arm. The third lever arm ensures stress-free transmission of the force of the coupling mechanism to the brake booster piston during operation as soon as the adjustment means moves backward and forward on the threaded spindle.

According to a preferred embodiment of the electromechanical brake booster, the second lever arm can be coupled in an articulated fashion to the brake booster piston by means of a pivot, and the length of the second lever arm from the pivot in a direction toward the first lever arm is longer than the length of the second lever arm from the pivot in a direction toward the third lever arm. In this arrangement, the characteristic of the non-linear assistance force and the maximum possible assistant force can be adjusted by means of the dimensioning of the lengths of the lever arms of the coupling mechanism.

According to a preferred embodiment of the electromechanical brake booster, the coupling mechanism can have a compensating lever arm, and the second lever arm can be coupled to the brake booster piston by the compensating lever arm, and one longitudinal end of the second lever arm can be coupled in an articulated fashion to the vehicle. This arrangement represents an alternative to the stress-free attachment of the brake booster piston to the coupling mechanism, in which vertical compensation of the movement of the brake booster piston is possible during operation. In this case, one longitudinal end of the compensating lever arm is coupled in an articulated fashion to the brake booster piston, while the other longitudinal end thereof is coupled in an articulated fashion to the second lever arm at a predetermined point along the longitudinal direction of the second lever arm.

According to a preferred embodiment of the electromechanical brake booster, the adjustment means can completely surround the threaded spindle in the common contact area. For this purpose, the adjustment means can be designed in the manner of a screw nut or of a sleeve with an internal thread matching the thread of the threaded spindle.

According to a preferred embodiment of the electromechanical brake booster, the ratio of the length of the second lever arm to the length of the first lever arm can be at least 2.5. The ratio of the lengths of the two lever arms determines not only the maximum possible assistance force but also the profile of the assistance force during the various positions of the adjustment means during operation, with a non-linear profile being a particularly preferred aim. As an alternative, it is also possible for the ratio to be less than 2.5 and greater than 1.5, this being sufficient especially in the case of vehicles with a low engine power since, in this case, correspondingly smaller assistance forces of the brake booster are required for braking

According to a preferred embodiment of the electromechanical brake booster, the brake pedal can be coupled to the brake booster piston by means of a further coupling mechanism. Thus, in particular, the brake booster piston can be coupled rigidly to a lever arm of the further coupling mechanism. Moreover, this lever arm can be coaxial with the axis of symmetry of the brake booster piston. As an alternative, the brake booster piston can also be coupled in an articulated fashion to a lever arm of the further coupling mechanism.

### BRIEF DESCRIPTION OF THE DRAWINGS

Preferred embodiments of the invention are explained in greater detail below with reference to the attached drawings, in which:

FIG. 1 shows a schematic view of the electromechanical brake booster under consideration,

FIG. 2 shows a schematic view of another electromechanical brake booster under consideration, having a modified attachment of the coupling mechanism to the brake booster piston and to the vehicle, and

FIG. 3 shows a desired non-linear relationship between the travel of the brake pedal s and the assistance force F of a brake booster.

### DETAILED DESCRIPTION

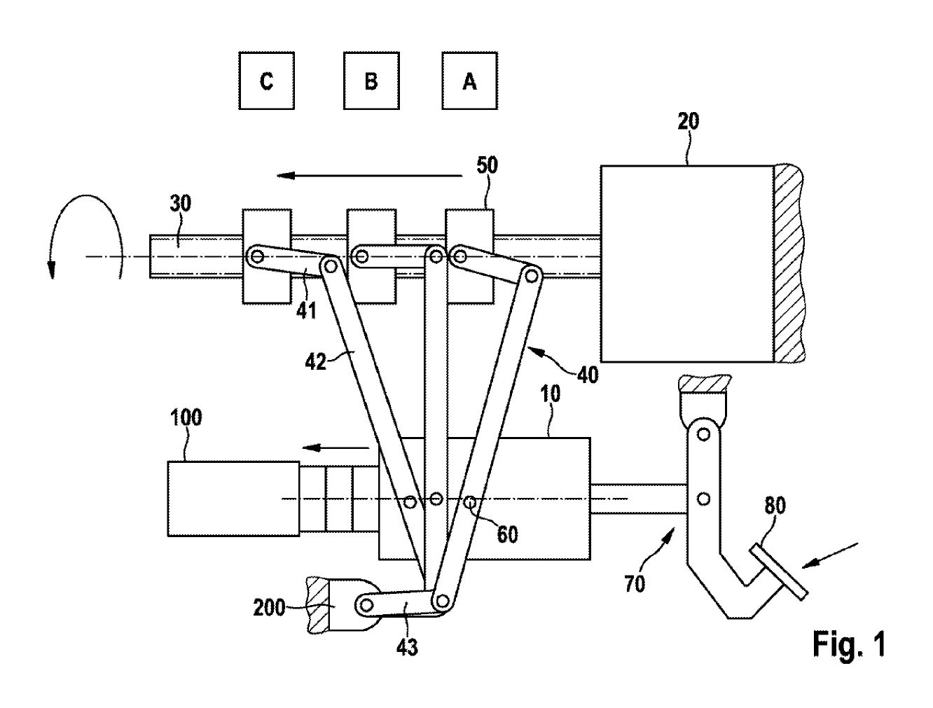

FIG. 1 shows a schematic view of the electromechanical brake booster under consideration. In the text which follows, identical reference signs denote identical components.

The brake booster under consideration comprises a brake booster piston 10, which exerts an assistance force on a brake master cylinder 100 in order to brake the vehicle 200 (not shown). The assistance force of the brake booster piston 10 is produced during the interaction of an electric motor 20 with an adjustment means 50, and is then transmitted to the brake booster piston 10 via a coupling mechanism 40, which interacts with the adjustment means 50 and implements a variable transmission ratio of the coupling mechanism 40, depending on its position. The coupling mechanism 40 operates according to a simple lever arm principle, in which the pulling force of the adjustment means 50 on the coupling mechanism 40 is intensified in proportion to the length of the lever arms of the coupling mechanism 40.

The electric motor 20 is arranged above the brake booster piston 10, with the axis of symmetry of the brake booster piston 10 and the axis of symmetry of the electric motor 20 lying in a common vertical plane. The output shaft of the electric motor 20 is formed by a threaded spindle 30, which extends substantially parallel to the axis of symmetry of the brake booster piston 10, starting from the electric motor 20. On the threaded spindle 30 there is an adjustment means 50, which is designed in the form of a sleeve with an internal thread matching the thread of the threaded spindle 30. The adjustment means 50 can thus completely surround the outer circumferential surface of the threaded spindle 30 or the common contact area between the two components over its entire length, for example. The adjustment means 50 is arranged on the threaded spindle 30 in such a way that it moves along the threaded spindle when the threaded spindle 30 rotates.

The coupling mechanism 40 comprises a first lever arm 41, a second lever arm 42 and a third lever arm 43, which are each coupled to one another in an articulated fashion by means of pivots, with in each case only one rotational degree of freedom being permitted in the connection of two lever arms. In this case, the lever arms 41, 42, 43 of the coupling mechanism 40 are arranged substantially in one vertical plane, and the movement thereof likewise takes place in said plane. The first lever arm 41 of the coupling mechanism 40 is coupled in an articulated fashion to the adjustment means 50. The second lever arm 42 is coupled in an articulated fashion to the brake booster piston 10 via a pivot 60, with the pivot 60 being arranged in the region of the outer circumferential surface of the brake booster piston 10, in a horizontal plane through the axis of symmetry thereof. The other longitudinal end of the third lever arm 43, which is arranged below the brake booster piston 10, is coupled in an articulated fashion to a mounting point on the vehicle 200, e.g. the body.

All the lever arms and pivots of the coupling mechanism 40 are arranged on each side of the brake booster piston 10 and of the adjustment means 50, with the result that the forces introduced on each side of the brake booster piston 10 compensate each other and hence do not exert a moment on the latter or on the adjustment means 50.

If no intensification is required, the adjustment means 50 is in the starting position A thereof, which is closest to the electric motor 20 on the longitudinal axis of the threaded spindle 30. If an assistance force is required during the operation of the electromechanical brake booster, the electric motor 20 is activated, as a result of which the adjustment means 50 moves out of its starting position A, away from the electric motor 20, in the direction of another position B, with the adjustment means 50 performing only a translatory movement along the longitudinal axis of the threaded spindle 30. During the movement of the adjustment means 50, the coupling thereof to the coupling mechanism 40 ensures that a force is introduced into the latter, which, depending on the position of the lever arms 41, 42, 43 of the coupling mechanism 40, is then intensified to different degrees and is transmitted by said mechanism in turn to the brake booster piston 10.

The maximum possible assistance force of the electromechanical brake booster is exerted on the brake booster piston 10 by the coupling mechanism 40 when the adjustment means 50 is in the end position C, in which the adjustment means 50 is furthest away from the electric motor 20. During operation, the adjustment means 50 thus performs an axial translatory movement along the longitudinal axis of the threaded spindle 50 within the two possible limiting positions A and C, with the transmission ratio of the coupling mechanism 40 changing variably in each case.

A brake pedal 80 is coupled to the brake booster piston 10 via a further coupling mechanism 70, wherein a lever arm of the further coupling mechanism 70 is coupled rigidly to the brake booster piston 10. Moreover, this lever arm is arranged coaxially with the axis of symmetry of the brake booster piston 10.

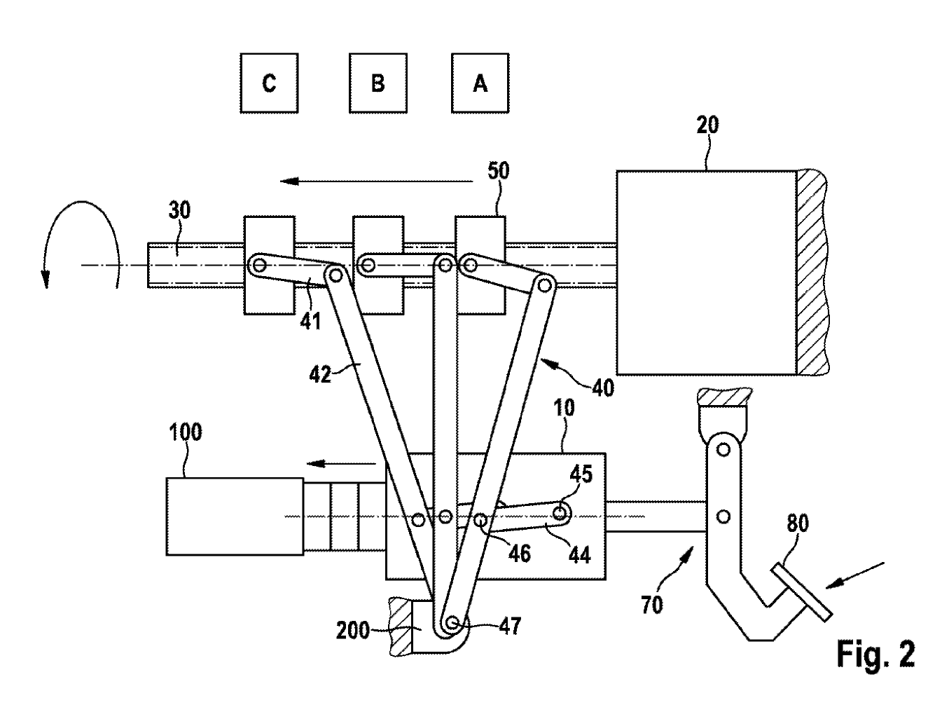

FIG. 2 shows a schematic view of another electromechanical brake booster under consideration, having a modified attachment of the coupling mechanism 40 to the brake booster piston 10 and the vehicle 200 (not shown). The arrangement of the electric motor 20, the threaded spindle 30, the adjustment means 50, the brake booster piston 10 and the further coupling mechanism 70 are identical with the electromechanical brake booster in FIG. 1, for which reason only the differences in respect of the construction of the coupling mechanism 40 and the coupling thereof to the brake booster piston 10 are explained below.

The coupling mechanism 40 comprises a first lever arm 41, a second lever arm 42 and a compensating lever arm 44. The first lever arm 41 is coupled in an articulated fashion to the adjustment means 50, while the other longitudinal end of the first lever arm 41 is coupled in an articulated fashion to the second lever arm 42. The other longitudinal end of the second lever arm 42 is coupled in an articulated fashion to the vehicle 200 via a pivot 47 at a mounting point, with the mounting point being below the brake booster piston 10.

The compensating lever arm 44 is coupled in an articulated fashion to the outer circumferential surface of the brake booster piston 10 by a pivot 45, with the pivot 45 being arranged in a horizontal plane through the axis of symmetry of the brake booster piston 10, in the region of an end section of the brake booster piston 10. The other longitudinal end of the compensating lever arm 44 is coupled in an articulated fashion to the second lever arm 42 by another pivot 46, with the other pivot 46 dividing the total length of the second lever arm 42 asymmetrically and being situated substantially in a vertical position like that of pivot 45. The length of the compensating lever arm 44 corresponds approximately to the length of the first lever arm 41. If the adjustment means 50 moves from the starting position A in the direction of one of positions B or C during operation, the compensating lever arm 44 ensures that the coupling mechanism 40 introduces the assistance force into the brake booster piston 10 in a strain-free manner, wherein said piston performs a slight movement in the vertical direction during operation.

The coupling mechanism 40 is likewise arranged symmetrically on both sides of the brake booster piston 10 and of the adjustment means 50, and therefore the lever arms 41, 42, 44 are each arranged on both sides of the brake booster piston 10.

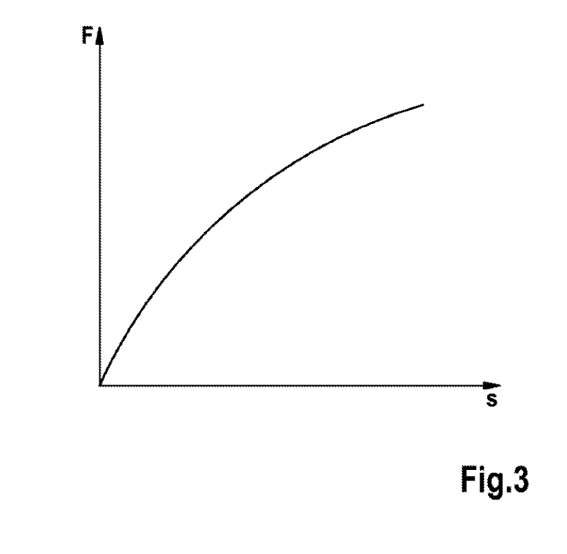

FIG. 3 shows a desired non-linear relationship between the travel of the brake pedal s and the assistance force F of a brake booster.

Owing to the lever arm effect, the assistance force of the brake booster F and the travel of the brake pedal s are non-linear relative to one another, this being advantageous for the operation of the brake booster. Thus, a small assistance force of the brake booster is supposed to be exerted on the brake master cylinder if the actuation of the brake pedal is only slight, whereas a very large assistance force of the brake booster for as rapid as possible braking of the vehicle is required in the case of a powerful actuation of the brake pedal. To provide as simple as possible a construction of an electromechanical brake booster with the characteristic of the assistance force F shown in FIG. 3, it can be implemented in a similar manner by means of the above-described arrangement of the lever arms and pivots of the coupling mechanism of the electromechanical brake booster under consideration.

The non-linear relationship in FIG. 3 also applies qualitatively to the overall force acting on the brake master cylinder, which is composed of the brake pedal force and the assistance force of the brake booster.

1. An electromechanical brake booster with adjustable non-linear assistance force, comprising:
a brake booster piston (10),
an adjustment means (50), which can be moved in a translatory fashion, and
a non-linear coupling mechanism (40) for coupling the brake booster piston (10) to the adjustment means (50) in order to exert a variable force on the brake booster piston (10).

2. The electromechanical brake booster as claimed in claim 1, further comprising:
a threaded spindle (30), and
an electric motor (20) for driving the threaded spindle (30),
wherein the threaded spindle is coupled to the adjustment means (50) in order to move the adjustment means (50) along a longitudinal axis of the threaded spindle by driving the threaded spindle.

3. The electromechanical brake booster as claimed in claim 1, wherein the coupling mechanism (40) has at least one first lever arm (41) and at least one second lever arm (42).

4. The electromechanical brake booster as claimed in claim 3, wherein the first and second lever arms (41, 42) of the coupling mechanism (40) are each arranged symmetrically on opposite sides of the adjustment means (50) and the brake booster piston (10).

5. The electromechanical brake booster as claimed in claim 3, wherein the first lever arm (41) of the coupling mechanism (40) is coupled in an articulated fashion to the adjustment means (50).

6. The electromechanical brake booster as claimed in claim 3, wherein the coupling mechanism (40) has a third lever arm (43), and the second lever arm (42) is coupled in an articulated fashion to the third lever arm (43), and the third lever arm (43) is coupled in an articulated fashion to the vehicle.

7. The electromechanical brake booster as claimed in claim 6, wherein the second lever arm (42) is coupled in an articulated fashion to the brake booster piston (10) by means of a pivot (60), and the length of the second lever arm (42) from the pivot (60) in a direction toward the first lever arm (41) is longer than the length of the second lever arm (42) from the pivot (60) in a direction toward the third lever arm (43).

8. The electromechanical brake booster as claimed in claim 3, wherein the coupling mechanism (40) has a compensating lever arm (44), and the second lever arm (42) is coupled to the brake booster piston (10) by the compensating lever arm (44), and one longitudinal end of the second lever arm (42) is coupled in an articulated fashion to the vehicle.

9. The electromechanical brake booster as claimed in claim 3, wherein the ratio of the length of the second lever arm (42) to the length of the first lever arm (41) is at least 2.5.
